(19) United States
(12) Patent Application Publication
(10) Pub. No.: US 2015/0171386 A1
(43) Pub. Date: Jun. 18, 2015

(54) BATTERY PACK

(71) Applicant: Samsung SDl Co., Ltd., Yongin-si (KR)

(72) Inventors: Seohoon Yang, Yongin-si (KR); Hyungshin Kim, Yongin-si (KR); Bongkoun Jang, Yongin-si (KR)

(73) Assignee: Samsung SDl Co., Ltd., Yongin-si (KR)

(21) Appl. No.: 14/243,314

(22) Filed: Apr. 2, 2014

(30) Foreign Application Priority Data
Dec. 18, 2013 (KR) 10-2013-0158730

(51) Int. Cl. H01M 2/10

(52) U.S. Cl. CPC H01M 2/1022; H01M 2220/30

(57) ABSTRACT

Provided is a battery pack including a switching member capable of smoothly sliding in a slide section while having a high fixing strength at an ON and/or OFF switching fixing terminal. In one embodiment, the battery pack includes a housing including a case and a cover coupled to the case, and a switching member inserted into the housing and including a sliding plate having a concave part formed on at least one of outer surfaces and a knob formed on an outer surface of the sliding plate, wherein the cover includes a first extension part extending to face an inner surface of the sliding plate and an interference part extending from the first extension part so as to make surface-contact with at least a portion of the outer surface of the sliding plate, and a hole through which the knob slides is formed on a sidewall of the case.

### CROSS-REFERENCE TO RELATED APPLICATIONS

This application claims the benefit of Korean Patent Application No. 10-2013-0158730 filed on Dec. 18, 2013, the contents of which are incorporated herein by reference in their entirety.

### BACKGROUND

1. Field

Aspects of the present invention relate to a battery pack.

2. Description of the Related Technology

As the mobile communication technology continuously develops and advances, existing mobile phones are replaced by smart phones or PDA phones offering high functionality beyond simple calling functions. In addition, with the development of electronic devices associated with the mobile communication technology, various types of mobile devices, such as a MP3 player, a GPS receiver, a portable computer including a notebook computer, and the like, become indispensable tools in the daily life of modern people.

However, in order to use such a mobile device outdoors for a long time, a separate charging step needs to be performed due to limitation of battery performance.

### SUMMARY OF CERTAIN INVENTIVE ASPECTS

Aspects of the present invention provide a battery pack including a switching member capable of smoothly sliding in a slide section while having a high fixing strength at an ON and/or OFF switching fixing terminal.

According to aspects of the present invention, there is provided a battery pack including a housing including a case and a cover coupled to the case, and a switching member inserted into the housing and including a sliding plate having a concave part formed on at least one of outer surfaces and a knob formed on an outer surface of the sliding plate, wherein the cover includes a first extension part extending to face an inner surface of the sliding plate and an interference part extending from the first extension part so as to make surface-contact with at least a portion of the outer surface of the sliding plate, and a hole through which the knob slides is formed on a sidewall of the case.

The sliding plate may further include convex parts formed at opposite corner regions of the outer surface so as to have a height greater than that of the concave part.

The interference part may make surface-contact with at least portions of the convex parts.

The interference part may have a greater width than the concave part.

The knob may slide to one end of the hole, the switching member may perform a turn-on operation, and when the knob slides to the other end of the hole, the switching member may perform a turn-off operation.

A surface-contact region between the interference part and the convex part when the knob is positioned at the one end or the other end of the hole may be larger than a surface-contact region between the interference part and the convex part while the knob is in the middle of sliding in the hole.

The cover may further include an upper protrusion protruding from the first extension part toward the inner surface of the sliding plate.

The upper protrusion and the inner surface of the sliding plate may make point-contact with each other.

The case may further include a second extension part extending to face the inner surface of the sliding plate.

The sliding plate may include a lower protrusion protruding from the inner surface of the sliding plate toward the second extension part.

The lower protrusion and the second extension part may make point-contact with each other.

At least one of the outer surfaces of the sliding plate may be a top surface, a bottom surface, an inner surface and/or an outer surface.

As described above, the battery pack includes a switching member capable of smoothly sliding in a slide section while having a high fixing strength at an ON and/or OFF switching fixing terminal.

Additional aspects and/or advantages of the invention will be set forth in part in the description which follows and in part will be obvious from the description or may be learned by practice of the invention.

### BRIEF DESCRIPTION OF THE DRAWINGS

The aspects, features and advantages of the present invention will be more apparent from the following detailed description in conjunction with the accompanying drawings, in which:

FIG. 1 is a perspective view of a battery pack according to an embodiment of the present invention;

FIG. 2 is a side view of the battery pack shown in FIG. 1;

FIG. 3 is a top view illustrating a state in which a cover is removed from the battery pack shown in FIG. 1;

FIG. 4 is an enlarged view of a portion 4 shown in FIG. 3;

FIG. 5 is a perspective view illustrating a switching member of the battery pack shown in FIG. 1;

FIG. 6 is a partially cross-sectional view taken along the line A-A′ of FIG. 2; and

FIGS. 7 to 9 are partially cross-sectional views illustrating operations of the switching member of the battery pack shown in FIG. 1.

### DETAILED DESCRIPTION OF CERTAIN INVENTIVE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, the thickness of layers and regions are exaggerated for clarity. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

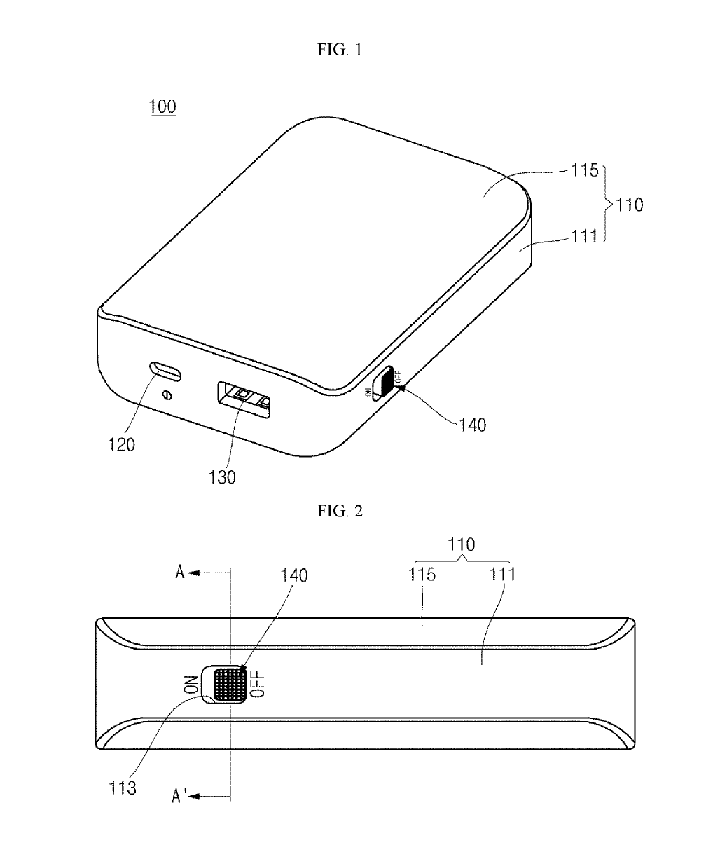

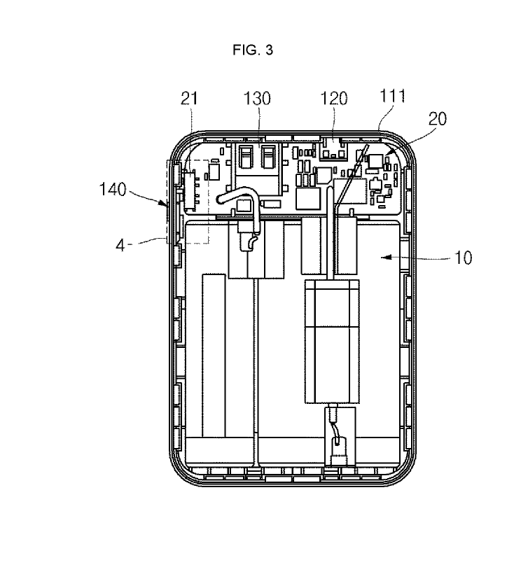

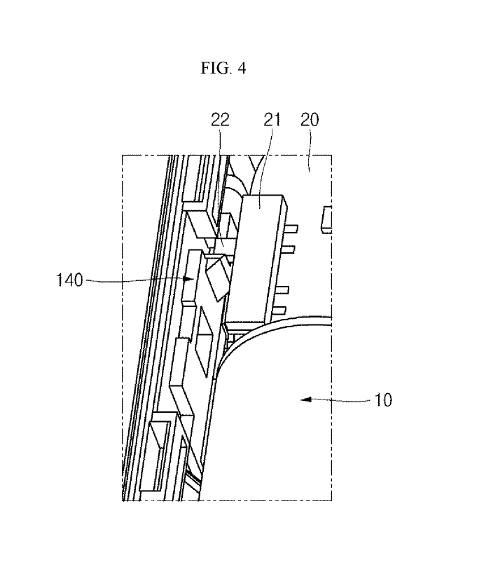

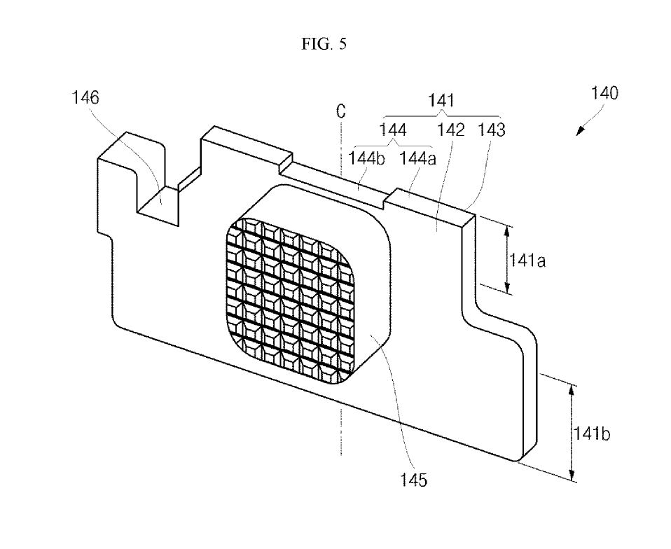

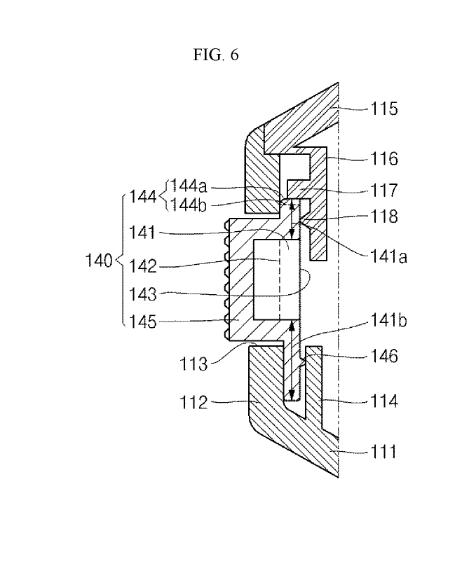

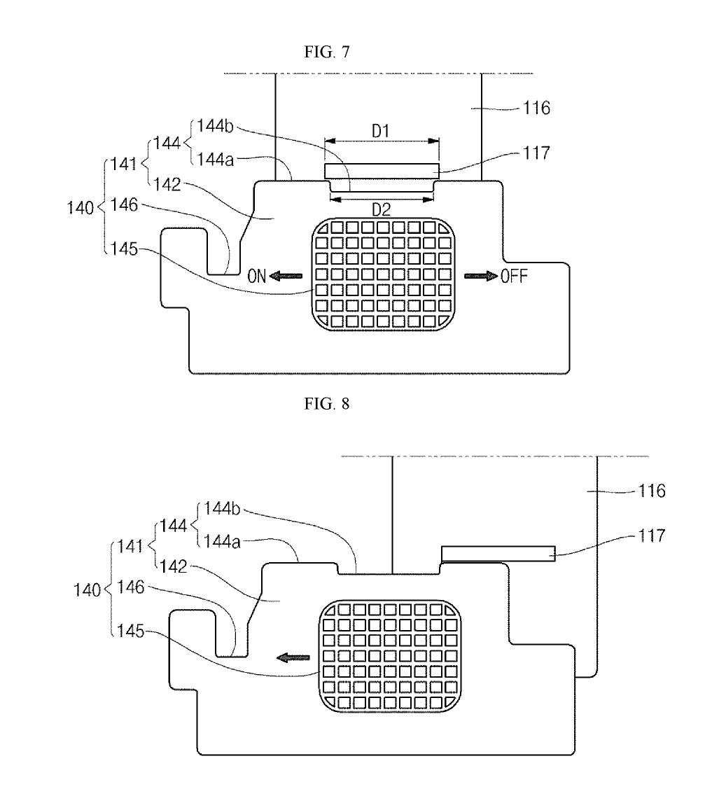

FIG. 1 is a perspective view of a battery pack according to an embodiment of the present invention, FIG. 2 is a side view of the battery pack shown in FIG. 1, FIG. 3 is a top view illustrating a state in which a cover is removed from the battery pack shown in FIG. 1, FIG. 4 is an enlarged view of a portion 4 shown in FIG. 3, FIG. 5 is a perspective view illustrating a switching member of the battery pack shown in FIG. 1, and FIG. 6 is a partially cross-sectional view taken along the line A-A′ of FIG. 2.

Referring to FIGS. 1 to 6, the battery pack 100 according to an embodiment of the present invention includes a housing 110, an input port 120, an output port 130 and a switching member 140.

The housing 110 includes a case 111 having a top opening and shaped of a box, and a cover 115 covering the opening of the case 111 and coupled to the case 111.

The case 111 and the cover 115 include a second extension part 114 (FIG. 6) and a first extension part 116, respectively, for preventing the switching member 140 from being dislodged. In addition, a hole 113 through which a knob 145 of the switching member 140 slides is formed on one surface 121 of the case 111. The hole 113, the second extension part 114 and the first extension part 116 will later be described in detail together with a switching member 120.

The case 111 has a receiving space for receiving at least one battery cell 10 and a circuit module 20 connected to the battery cell 10.

The battery cell 10 may be formed by accommodating a stacked or wound electrode assembly (not shown) and an electrolytic solution in a cylindrical or prismatic can.

The circuit module 20 is configured such that protection circuits are mounted on a circuit board shaped of a substantially rectangular plate and the protection circuits are electrically connected to each other in a circuit pattern. Here, the circuit module 20 controls charging and discharging of the battery cell 10 and controls over-charge and over-discharge of the battery cell 10.

Here, the circuit module 20 has a switch 21 attached to perform ON/OFF operations of the circuit module 20.

The switch 21 is disposed to be adjacent to a sidewall 112 of the case 111 and includes a sliding knob 22 facing the sidewall 112 of the case 111. Here, the present invention does not limit the kind of the switch 21 so long as it is capable of performing ON/OFF operations of the circuit module 20.

The operation of the sliding knob 22 will later be described in detail together with the switching member 130.

The cover 115 is coupled to a top surface of the sidewall 112 of the case 111 to seal the opening of the case 111. Here, coupling of the case 111 and the cover 115 is preferably achieved by fastening a coupling protrusion (not shown) and a coupling groove (not shown) to each other by an interference fit manner coupled to each other, but aspects of the present invention are not limited thereto.

The input port 120 and the output port 130 are electrically connected to the circuit module 20 and are electrically and mechanically connected to separate external input and output connectors (not shown), but aspects of the present invention are not limited thereto.

The switching member 140 includes a sliding plate 141, a knob 145 and a receiving part 146 and is disposed between the switch 21 and the sidewall 112 of the case 111.

The sliding plate 141 is shaped of a plate having an outer surface 142 facing the outside of the housing 110, an inner surface 143 facing the inside of the housing 110, and a top surface 144 facing the top of the housing 110.

Here, a second extension part 114 upwardly extending from the case 111 is formed at a region spaced a predetermined distance apart from the sidewall 112 of the case 111 so as to face the inner surface 143 of the sliding plate 141.

In addition, a first extension part 116 downwardly extending from the cover 115 is formed on the cover 115 so as to face the inner surface 143 of the sliding plate 141.

That is to say, an upper region 141a of the sliding plate 141 is disposed between the sidewall 112 of the case 111 and the first extension part 116 of the cover 115 and slides between the sidewall 112 and the first extension part 116.

In addition, a lower region 141b of the sliding plate 141 is disposed between the sidewall 112 of the case 111 and the second extension part 114 of the case 111 and slides between the sidewall 112 and the second extension part 114.

Here, an upper protrusion 118 for pressing the inner surface 143 of the upper region 141a of the sliding plate 141 to the outside of the housing 110 is formed on the first extension part 116. The upper protrusion 118 and the inner surface 143 of the upper region 141a of the sliding plate 141 make point-contact with each other, thereby reducing an interference area during sliding of the sliding plate 141.

In addition, a lower protrusion 146 making point-contact with the second extension part 114 is formed on the inner surface 143 of the lower region 141b of the sliding plate 141. Although not shown, as described above, the lower protrusion 146 may be formed on one surface of the second extension part 114 to make point-contact with the inner surface 143 of the lower region 141b of the sliding plate 141.

The top surface 144 of the sliding plate 141 has convex parts 144a and a concave part 144b.

The convex or raised parts 144a are formed at corner regions of the top surface 144 so as to have a predetermined height. The concave or lowered part 144b is formed at a roughly central region C (FIG. 5) of the top surface 144 and is recessed to a predetermined depth so as to have a height smaller than the height of each of the convex parts 144a.

In an exemplary embodiment, the concave part 144b is formed on only the top surface 144 of the sliding plate 141, but aspects of the present invention are not limited thereto. The concave part 144b may be formed on a bottom surface, the outer surface 142, the inner surface 143 and/or the top surface 144 of the sliding plate 141.

Here, an interference part 117 is formed on the first extension part 116, the interference part 117 protruding to the outside of the housing 110 and making surface-contact with at least a portion of the top surface 144 of the sliding plate 141. In detail, the interference part 117 makes surface-contact with at least a portion of the top surface 144 of the sliding plate 141. In other words, the interference part 117 does not make contact with the concave part 144b of the top surface 144.

The contact relationship between the interference part 117 and the convex parts 144a of the top surface 144 will later be described together with the operation of the switching member 140.

The knob 145 protrudes from the outer surface 142 of the sliding plate 141 to the outside of the housing 110. In addition, the knob 145 outwardly protrudes while passing through the hole 113 of the case 111. Here, the knob 145 is capable of sliding from one terminal (e.g., an ON terminal) to the other terminal (e.g., an OFF terminal) through the hole 113.

The receiving part 146 extends from one side of the sliding plate 141 in parallel and forms a space in which the sliding knob 22 of the switch 21 is placed and fixed. That is to say, through the sliding operation of the switching member 140, the sliding knob 22 fixed to the receiving part 146 slides from the one terminal to the other terminal, thereby allowing the switch 21 to perform turn-on and/or turn-off operations.

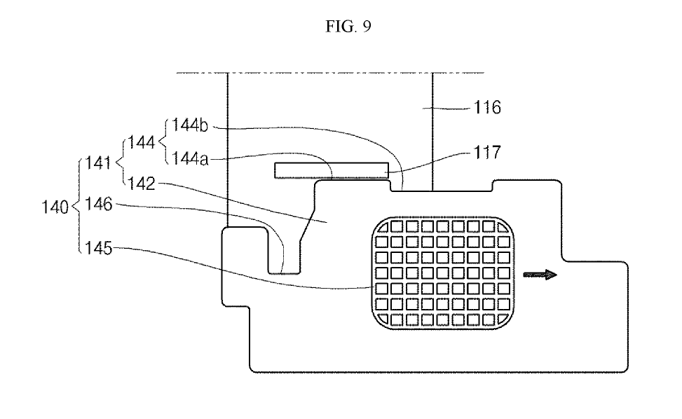

FIGS. 7 to 9 are partially cross-sectional views illustrating operations of the switching member of the battery pack shown in FIG. 1.

Next, the operation of the switching member 140 will be described with reference to FIGS. 7 to 9.

First, referring to FIG. 7, when the switching member 140 slidably moves from the one terminal (ON) or the other terminal (OFF), the interference part 117 and the convex parts 144a make surface-contact with each other only at a predetermined region. That is to say, in a section in which the switching member 140 slides, a frictional force between the interference part 117 and the convex parts 144a is weak, so that the switching member 140 smoothly slides.

Here, a width D1 of the interference part 117 is greater than a width D2 of the concave part 144b, which is for the purpose of preventing the one terminal and/or the other terminal of the interference part 117 from being caught by stepped parts between the convex parts 144a and the concave part 144b when the switching member 140 slides.

Next, referring to FIGS. 8 and 9, in a section in which the switching member 140 slidably moves from the one terminal (ON) to the other terminal (OFF) to then be positioned, the interference part 117 makes surface-contact with most regions of the convex parts 144a.

That is to say, quite strong a frictional force is generated between the interference part 117 and the convex parts 144a at a switching fixing terminal (one terminal (ON) or the other terminal (OFF), thereby fixing the switching member 140 with a high fixing strength.

Although the battery pack of the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A battery pack comprising:
a housing including a case and a cover coupled to the case; and
a switching member inserted into the housing and including a sliding plate having a concave part formed on at least one of outer surfaces and a knob formed on an outer surface of the sliding plate,
wherein the cover includes a first extension part extending to face an inner surface of the sliding plate and an interference part extending from the first extension part so as to make surface-contact with at least a portion of the outer surface of the sliding plate, and a hole through which the knob slides is formed on a sidewall of the case.

2. The battery pack of claim 1, wherein the sliding plate further includes convex parts formed at opposite corner regions of the outer surface so as to have a height greater than that of the concave part.

3. The battery pack of claim 2, wherein the interference part makes surface-contact with at least portions of the convex parts.

4. The battery pack of claim 3, wherein the interference part has a greater width than the concave part.

5. The battery pack of claim 3, wherein when the knob slides to one end of the hole, the switching member performs a turn-on operation, and when the knob slides to the other end of the hole, the switching member performs a turn-off operation.

6. The battery pack of claim 5, wherein a surface-contact region between the interference part and the convex part when the knob is positioned at the one end or the other end of the hole is larger than a surface-contact region between the interference part and the convex part while the knob is in the middle of sliding in the hole.

7. The battery pack of claim 1, wherein the cover further includes an upper protrusion protruding from the first extension part toward the inner surface of the sliding plate.

8. The battery pack of claim 7, wherein the upper protrusion and the inner surface of the sliding plate make point-contact with each other.

9. The battery pack of claim 1, wherein the case further includes a second extension part extending to face the inner surface of the sliding plate.

10. The battery pack of claim 9, wherein the sliding plate includes a lower protrusion protruding from the inner surface of the sliding plate toward the second extension part.

11. The battery pack of claim 10, wherein the lower protrusion and the second extension part make point-contact with each other.

12. The battery pack of claim 1, wherein at least one of the outer surfaces of the sliding plate is a top surface, a bottom surface, an inner surface and/or an outer surface.

13. A battery pack comprising:
a housing having a first surface that defines an opening;
a switch member mounted to the first surface of the housing and so as to be movable between a first and second position in a direction that is parallel to the plane of the first surface, wherein the switch member includes a knob that extends through the opening in the first surface and wherein the switch member has an inner surface that has a raised portion and a recessed portion wherein the inner surface of the switch member is positioned adjacent an inner side of the first surface of the housing;
an interference part that is coupled to the housing so as to extend adjacent the inner side of the housing, wherein the interference part engages with the inner surface of the switch member so that the interference part induces a first frictional engagement when the interference part engages with the raises portion of the inner surface of the switch member and a second frictional engagement with the interference part engages with the recessed portion of the inner surface of the switch member when the switch member is moved between the first and second position.

14. The battery pack of claim 13, wherein the interference part has a width greater than the width of the recessed portion of the inner surface of the switch member.

15. The battery pack of claim 13, further comprising a first and a second protrusion that is coupled to the housing and engages with the switch member so as to bias the switch member towards the inner side of the housing.

16. The battery pack of claim 15, wherein the first and second protrusions make point-contact with the switch member.

17. The battery pack of claim 13, wherein the switch member includes a first and a second raised portions with the recessed portion interposed between the first and second raised portions.

18. The battery pack of claim 17, wherein the switch member has a first side and a second side and at least one lateral side interposed between the first and second side and wherein the knob is formed on the first side and the inner surface is formed on the at least one lateral side.

19. The battery pack of claim 17, wherein the raised portions comprise convex parts and the recessed surface comprise a concave part.

20. The battery pack of claim 17, wherein a surface-contact region between the interference part and the raised portions when the knob is positioned at one end or the other end of the opening is larger than a surface-contact region between the interference part and the convex part when the knob is in the middle of opening.
